(19) United States
(12) Patent Application Publication
(10) Pub. No.: US 2025/0316434 A1
(43) Pub. Date: Oct. 9, 2025

(54) PROTECTIVE COVER WITH A FLIP CLOSURE

(71) Applicant: Custom Coating Innovations, Inc., Belleville, IL (US)

(72) Inventors: George Genung, St. Louis, MO (US); Michael Mattera, Southbury, CT (US)

(21) Appl. No.: 19/170,895

(22) Filed: Apr. 4, 2025

Related U.S. Application Data
(60) Provisional application No. 63/574,404, filed on Apr. 4, 2024.

(51) Int. Cl. H01H 85/20; H01H 85/25

(52) U.S. Cl. CPC H01H 85/2045; H01H 85/25

(57) ABSTRACT

A protective cover with a flip closure is adapted and configured to enable the cover to be positioned by a tool over a remote object, then closed by the tool over the object and then secured closed by the tool to protect the object.

### CROSS-REFERENCE TO RELATED APPLICATION

This application claims the benefit of the filing date of Provisional Patent Application Ser. No. 63/574,404, which was filed on Apr. 4, 2024, and is incorporated herein by reference.

### FIELD OF THE INVENTION

This disclosure pertains to a protective cover with a flip closure device that enables a cover to be positioned over a remote object, and then closed remotely over the object, with a flip closure of the cover then closed to contain and protect the object in the cover. More specifically, this disclosure is directed to a fuse cutout cover with a flip closure. The cover can be opened and remotely positioned over a high voltage fuse cutout. The cover can then be remotely closed over the fuse cutout and the flip closure on the cover can be remotely closed to secure the cover over the fuse cutout.

### BACKGROUND

Protective covers are used on components of electric power distribution systems, for example power line fixtures and hardware such as fuse cutouts and fuse barrels to protect the components. The covers protect the components from damage resulting from contact of the components with animals such as birds or contact with objects of the surrounding environment such as tree branches. Protective covers of this type are typically comprised of two or more separate pieces that are assembled over the components being protected and then held together by fasteners or pins.

Many common components of electric power distribution systems are positioned remotely or high above the ground on utility poles or other similar structures. This remote positioning of these components makes them difficult to access for installation of protective covers on the components. The remote positioning often requires that a protective cover be installed by a technician using an elongate pole or hot stick. The technician manually holds and manipulates the hot stick at the proximal end of the hot stick while using the distal end of a hot stick to position the protective cover on a component of the electric power distribution system. The technician must then further manipulate the hot stick to secure the protective cover to the component. With the protective cover being comprised of two or more pieces that are first assembled together over the component being protected and then secured together by separate fasteners or pins, remotely assembling a protective cover on a component is a very difficult task.

The current procedure for positioning protective covers over components of power distribution systems and assembling the covers on the components is very difficult to perform and very time consuming.

### SUMMARY

The cover with a flip closure of this disclosure has a unique and non-obvious construction that enables the cover to be easily and remotely positioned over a fuse cutout of an electric power distribution system and then remotely secured to the fuse cutout.

The cover has a configuration that generally resembles the exterior configuration of the fuse cutout to be protected by the cover. When the cover is configured to protect a component of a power distribution system other than a fuse cutout, the cover is provided with a configuration that generally resembles the exterior configuration of that other component.

The cover has a first section that has a configuration of a first side of the fuse cut out to be protected. A first panel extends from one side of the first section.

The cover has a second section that has a configuration of a second side of the fuse cutout to be protected. The first section and the second section are configured to cover opposite sides of the fuse cutout. A second panel extends from one side of the second section. When the first section and the second section of the cover are positioned over opposite sides of the fuse cut out, the first panel and the second panel are positioned side-by-side.

The first section of the cover and the second section of the cover are connected together by a hinge mechanism. The hinge mechanism enables the first section and the second section to be pivoted away from each other. The hinge mechanism also enables the first section and the second section to be pivoted toward each other.

When the first section and the second section of the cover are pivoted away from each other, the first panel and the second panel are moved away from each other.

When the first section and the second section of the cover are pivoted toward each other, the first panel and the second panel are moved toward each other and are positioned side-by-side.

A clamp is attached to one of the first panel and the second panel. The clamp is attached to the panel by a pivoting connection. The pivoting connection enables the clamp to be pivoted to an open position away from the first panel and the second panel, and to be pivoted toward the first panel and the second panel when the first panel and second panel are positioned side-by-side. When the clamp is pivoted toward the first panel and the second panel with the first panel and the second panel position side-by-side, the clamp engages over the first panel and the second panel and holds the first panel and the second panel side-by-side. In this closed position of the clamp, the clamp also closes the first section and the second section of the cover together.

In use of the cover, the clamp is moved to the open position and the first section and the second section of the cover are initially pivoted apart and set in their opened positions. With the first section and the second section in their opened positions, the cover is configured to be remotely positioned over a component of a power distribution system to be protected by the cover, for example the fuse cutout. The opened first section and second section of the cover can then be remotely positioned by a hot stick or by other equivalent means downwardly toward the fuse cutout, with the fuse cut out passing upwardly between the opened first section and second section of the cover. The cover is continued to be remotely moved downwardly over the fuse cutout until the first section and the second section of the cover are positioned on opposite sides of the fuse cutout.

With the first section and the second section of the cover positioned on opposite sides of the fuse cutout, the first section and the second section can then be pivoted or moved remotely toward each other to closed positions of the first section and the second section of the cover. The first section and the second section of the cover are moved to positions on opposite sides of the fuse cutout, enclosing the fuse cutout between the first section and the second section of the cover. This movement of the first section and the second section of the cover also moves the first panel and the second panel to side-by-side positions.

With the first panel and the second panel in side-by-side positions, the clamp can then be remotely moved by pivoting the clamp toward the side-by-side first panel and second panel. The clamp is continued to be pivoted toward the side-by-side first panel and second panel until the clamp engages over opposite sides of the side-by-side first panel and second panel. This positioning of the clamp over the opposite sides of the first panel and second panel secures the first panel and the second panel in their side-by-side positions and locks the first section and the second section of the cover over opposite sides of the fuse cutout.

The features, functions and advantages that have been discussed can be achieved independently in various embodiments or may be combined in yet other embodiments, further details of which can be seen with reference to the following description and drawings.

### DESCRIPTION OF THE DRAWINGS

Further objects and features of the fuse cutout cover with a flip closure of this disclosure are set forth in the following detailed description of the cover and in the drawing figures.

FIG. 1 is a representation of a side elevation view of the first section of the fuse cutout cover with a flip closure of this disclosure with the flip closure clamp in the open position. The opposite side elevation view of the second section of the fuse cutout cover is a substantial mirror image of FIG. 1.

FIG. 2 is a representation of a side elevation view of the first section of the fuse cutout cover with the flip closure clamp having been moved from the open position toward the closed position.

FIG. 3 is representation of a side elevation view of the first section of the fuse cutout cover with the flip closure clamp having been moved to the closed position.

FIG. 4 is a representation of a side elevation view of the fuse cutout cover similar to that of FIG. 3 with the flip closure clamp in the closed position.

FIG. 5 is a representation of a left side elevation view of the fuse cutout cover of FIG. 4.

FIG. 6 is a representation of a top perspective view of the fuse cutout cover of FIG. 4.

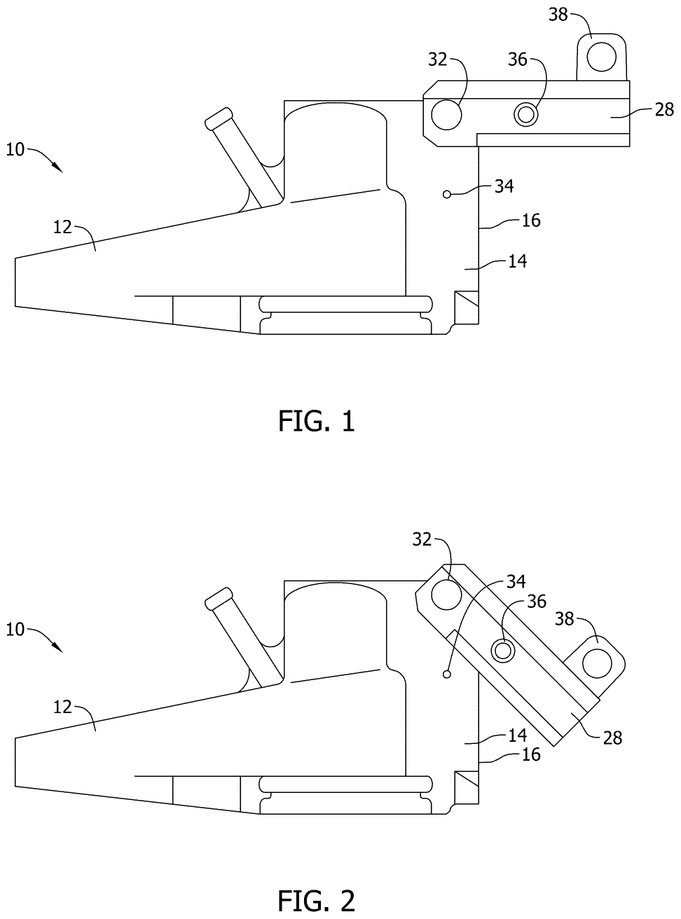

### DETAILED DESCRIPTION

The features and component parts of the fuse cutout cover with a flip closure 10 to be described herein are constructed of a material that provides the cover with a sufficient structural strength to enable the cover to function in the manner to be described. Additionally, the material of the cover 10 is an electrical insulator and has heat resistant and flame resistant properties and is resiliently flexible enabling the cover to be remotely flexed to an opened configuration by a remote tool and then resiliently moved to its original closed configuration when the tool is removed. The cover 10 could be constructed of other equivalent types of materials.

The cover with a flip closure 10 of this disclosure is resiliently flexible and has a unique and non-obvious construction that enables the cover to be easily and quickly positioned over a fuse cutout of an electric power distribution system and then secured to the fuse cutout. The construction of the cover with the flip closure enables the positioning and securing of the cover 10 over the fuse cutout or other component while using a hot stick and without requiring separate fasteners or pins. Although the cover with the flip closure 10 of this disclosure is described herein as being employed to cover and protect a fuse cutout, the cover with the flip closure 10 could be employed in protecting other components of an electric power distribution system.

The cover 10 has a configuration that generally resembles the exterior configuration of the fuse cutout or other component to be protected by the cover. When the cover 10 is configured to protect a component of a power distribution system other than a fuse cutout such as a bushing, a lightning/surge arrestor, a line post insulator, etc., the cover 10 is provided with a configuration that generally resembles the exterior configuration of that other component to be protected. The configuration of the cover 10 can be adapted and configured to provide the cover with the ability to be easily positioned remotely on the component to be protected.

The cover 10 has a first section 12 that has a configuration of a first side of the fuse cut out to be protected. A first panel 14 extends from one side of the first section. The first panel 14 has a general flat, rectangular configuration and extends from the first section 12 of the cover 10 to a distal edge 16 of the first panel.

The cover 10 has a second section 18 that has a configuration of a second side of the fuse cutout or other component to be protected. The second side of the fuse cutout is opposite the first side of the fuse cutout. Thus, the first section 12 and the second section 18 are configured to cover opposite sides of the fuse cutout or other component. A second panel 22 extends from one side of the second section 18. The second panel 22 also has a general flat, rectangular configuration and extends from the second section 18 to a distal edge 24 of the second panel. When the first section 12 and the second section 18 of the cover 10 are positioned on opposite sides of the fuse cutout, the first panel 14 and the second panel 22 are positioned in overlapping, side-by-side positions.

The first section 12 of the cover 10 and the second section 18 of the cover are connected together by a hinge mechanism 26 or a pivoting structure that, together with the resiliency of the material of the cover 10 enable the first panel and the second panel to be moved between closed and opened relative positions. Various different types of hinge mechanisms could be employed. For example, the first section 12 and the second section 18 could be connected together by a living hinge formed between the two sections. The hinge mechanism 26 and resiliency enable the first section 12 and the second section 18 to be pivoted away from each other. When the first section 12 and the second section 18 are pivoted away from each other, there is a sufficient area between the first section 12 and the second section 18 to position the fuse cutout or other component between the first section and the second section. With the fuse cutout positioned between the first section 12 and the second section 18 of the cover, the hinge mechanism 26 and resiliency enable the first section and the second section to be pivoted toward each other. When the first section 12 and the second section 18 are pivoted toward each other with the fuse cutout between the two sections, the fuse cutout is enclosed between the first section and the second section of the cover.

When the first section 12 and the second section 18 of the cover 10 are pivoted away from each other, the first panel 14 and the second panel 22 are moved away from each other. When the first section 12 and the second section 18 of the cover 10 are pivoted toward each other, the first panel 14 and the second panel 22 are moved to be positioned side-by-side.

A clamp 28 is attached to one of the first panel 14 and the second panel 22. The clamp 28 is represented as being attached to the first panel 14, but the clamp could be attached to the second panel 22. The clamp 28 is attached to the panel 14 by a pivoting connection 32. The pivoting connection 32 is positioned at the top of the clamp 28 where gravity will assist in pivoting the clamp 28 downward about the pivoting connection 32 and hold the clamp 28 in position extending downward from the pivoting connection 32 and over the first panel 14 and second panel 22. The pivoting connection 32 enables the clamp 28 to be pivoted away from the first panel 14 and the second panel 22 to an open position of the clamp when the first panel and second panel are moved away from each other, and to be pivoted toward the first panel 14 and the second panel 22 when the first panel and second panel are positioned side-by-side. The clamp 28 has a general U-shaped cross section configuration with a slot in the clamp that is dimensioned to receive the side-by-side first panel 14 and second panel 22 in the slot. The slot is positioned by the pivoting connection 32 facing toward the side-by-side first panel 14 and second panel 22. When the clamp 28 is pivoted toward the first panel 14 and the second panel 22 with the first panel and the second panel position side-by-side, the first panel 14 and the second panel 22 move into the slot in the clamp 28 and the U-shaped cross section configuration of the clamp 28 engages over the first panel 14 and the second panel 22 and holds the first panel and the second panel side-by-side. In this closed position of the clamp 28, the clamp also secures the first section 12 and the second section 18 of the cover 10 together.

A lock pin 34 extends and projects outwardly from the first panel 14. There could also be a lock pin provided on the second panel 22.

A first cylinder 36 extends from the clamp 28. There could also be a second cylinder on the opposite side of the clamp 28 from the first cylinder 36. The first cylinder 36 forms a first socket in the interior of the cylinder 36 on the clamp 28 with the socket being configured and dimensioned to receive the lock pin 34 in the socket when the clamp 28 is moved to the closed position over the first panel 14 and the second panel 22. The engagement of the lock pin 34 in the first cylinder 36 locks the clamp 28 in the closed position over the first panel 14 and the second panel 22 and secures the first section 12 and the second section 18 of the cover 10 closed.

A tab 38 projects from an opposite end of the clamp 28 from the pivoting connection 32. The tab 38 projecting from the end of the clamp 28 makes the tab 38 easily engageable by a tool such as a hot stick. The hot stick can then be used to move the clamp 28 with the hot stick between the opened and closed positions of the clamp relative to the first panel 14 and the second panel 22.

In use of the cover 10, the clamp 28 is moved to the open position and the first section 12 and the second section 18 are initially pivoted apart and set in their opened positions. With the first section 12 and the second section 18 in their opened positions, the cover 10 is configured to be remotely positioned over a component of a power distribution system to be protected by the cover, for example the fuse cutout. The opened first section 12 and second section 18 of the cover 10 can then be remotely positioned by a hot stick or by other equivalent means downwardly over the fuse cutout, with the fuse cut out passing upwardly between the opened first section 12 and second section 18 of the cover 10. The cover 10 is continued to be remotely moved downwardly over the fuse cutout until the first section 12 and the second section 18 of the cover are position on opposite sides of the fuse cutout.

With the first section 12 and the second section 18 of the cover 10 positioned on opposite sides of the fuse cutout to be protected, the first section 12 and the second section 18 can then be pivoted or moved remotely toward each other. The first section 12 and the second section 18 of the cover 10 are moved to closed positions on opposite sides of the fuse cutout, enclosing the fuse cutout between the first section 12 and the second section 18 of the cover 10. This movement of the first section 12 and the second section 18 of the cover 10 also moves the first panel 14 and the second panel 22 to side-by-side positions.

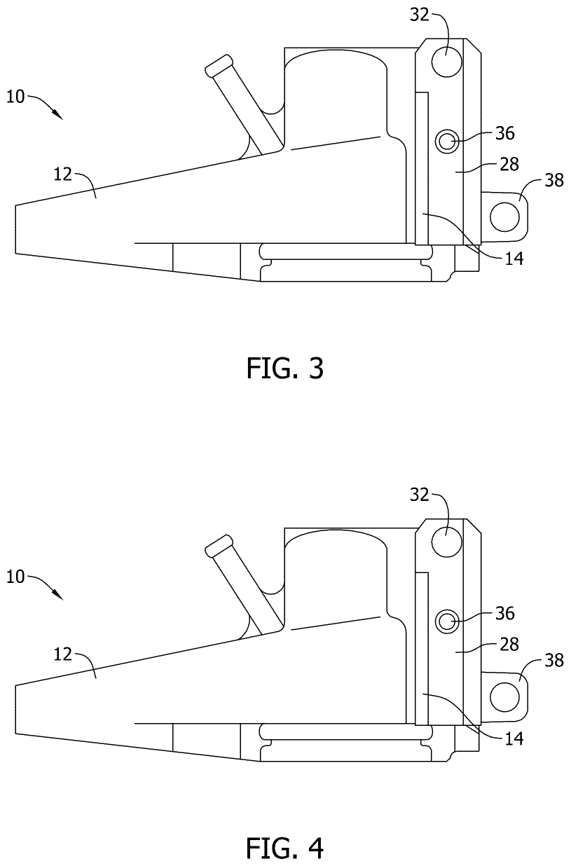

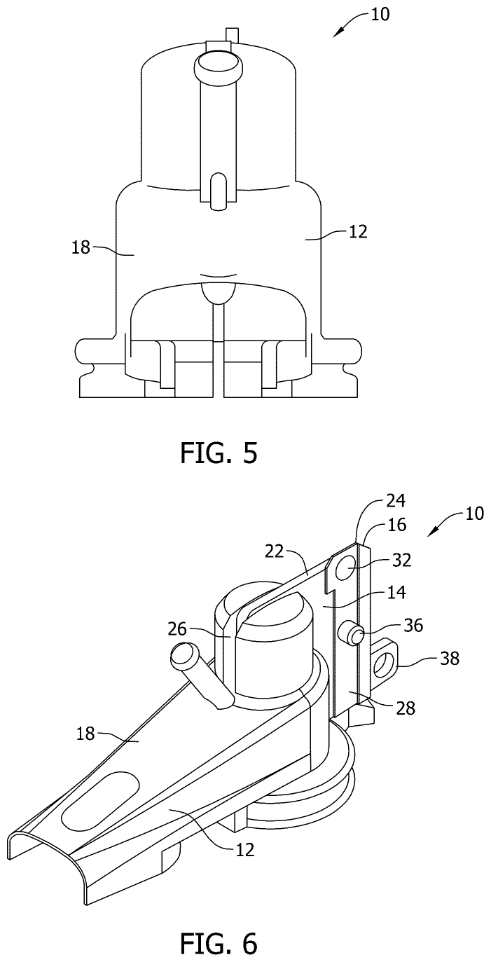

With the first panel 14 and the second panel 22 in side-by-side positions, the clamp 28 can then be remotely moved by pivoting the clamp downward toward the side-by-side first panel 12 and second panel 18 as represented in FIG. 2. The clamp 28 is continued to be pivoted toward the side-by-side first panel 14 and second panel 22 until the first panel 14 and second panel 22 move into the slot in the clamp 28 and the clamp 28 engages over opposite sides of the first panel 14 and second panel 22 as represented in FIG. 3. This positioning of the clamp 28 over the opposite sides of the first panel 14 and second panel 22 secures the first panel and the second panel in their side-by-side positions and locks the first section 12 and the second section 18 of the cover 10 over opposite sides of the fuse cutout.

As various modifications could be made in the construction of the protective cover with a flip closure and it's method of operation herein described and illustrated without departing from the scope of the invention, it is intended that all matter contained in the foregoing description or shown in the accompanying drawings shall be interpreted as illustrative rather than limiting. Thus, the breadth and scope of the present disclosure should not be limited by any of the above described exemplary embodiments, but should be defined only in accordance with the following claims appended hereto and their equivalents.

1. A protective cover comprising:
a first section of the cover, the first section of the cover being adapted and configured for receiving and containing a first portion of a component that is separate from the cover;
a second section of the cover, the second section of the cover being adapted and configured for receiving and containing a second portion of the component that is separate from the cover;
a first panel extending from the first section of the cover;
a second panel extending from the second section of the cover;
a clamp on the first panel, the clamp being adapted and configured to be movable on the first panel between an opened position and a closed position, whereby when the clamp is in the opened position the first panel and the second panel can be moved apart enabling a separate component to be positioned between the first panel and the second panel and between the first section and the second section of the cover, the first panel and the second panel can then be moved to side-by-side positions where the clamp is movable to the closed position over the first panel and the second panel securing the first panel and the second panel in the side-by-side positions and securing the component in the cover.

2. The protective cover of claim 1, further comprising:
the clamp is connected by a pivot connection to the first panel, the pivot connection is adapted and configured to enable the clamp to be pivoted remotely from the opened position of the clamp to the closed position of the clamp.

3. The protective cover of claim 2, further comprising:
a lock pin on the first panel,
a cylinder on the clamp, the cylinder being adapted and configured to receive the lock pin in the cylinder when the clamp is moved to the closed position whereby the pin received in the cylinder secures the clamp in the closed position.

4. The protective cover of claim 2, further comprising:
a tab on the clamp, the tab being positioned on an opposite end of the clamp from the pivot connection, the tab being adapted and configured to be engaged by a tool enabling the tab to be manipulated remotely by the tool.

5. A protective cover comprising:
a first section of the cover, the first section of the cover being configured to cover over a first portion of an exterior surface of a component that is separate from the cover and lay over and conform to the first portion of the exterior surface of the component, and being adapted and configured for receiving and containing the first portion of the exterior surface of the component;
a second section of the cover, the second section of the cover being configured to cover over a second portion of the exterior surface of the component and lay over and conform to the second portion of the exterior surface of the component, and being adapted and configured for receiving and containing the second portion of the exterior surface of the component;
a first panel extending from the first section of the cover, the first panel having a planer configuration;
a second panel extending from the second section of the cover, the second panel having a planar configuration;
a clamp on the first panel, the clamp having a slot in the clamp, the clamp being adapted and configured to be movable on the first panel between an opened position and a closed position, whereby when the clamp is in the opened position the first panel and the second panel can be moved apart enabling a separate component to be positioned between the first panel and the second panel and between the first section and the second section of the cover, the first panel and the second panel can then be moved to side-by-side positions where the clamp is configured to be moved to position the first panel and the second panel in the slot with the clamp positioned over the first panel and the second panel securing the first panel and the second panel in the side-by-side positions and securing the component in the cover.

6. The protective cover of claim 5, further comprising:
the clamp is connected by a pivot connection to the first panel, the pivot connection is positioned at a top of the clamp and is adapted and configured to enable the clamp to be pivoted remotely from the opened position of the clamp to the closed position of the clamp.

7. The protective cover of claim 6, further comprising:
a lock pin on the first panel,
a cylinder on the clamp, the cylinder containing a socket that is adapted and configured to receive the lock pin in the socket in the cylinder when the clamp is moved to the closed position whereby the pin received in the cylinder secures the clamp in the closed position.

8. The protective cover of claim 6, further comprising:
a tab on the clamp, the tab being positioned on an opposite end of the clamp from the pivot connection, the tab being adapted and configured to be engaged by a tool enabling the tab to be manipulated remotely by the tool.
